(19) United States
(12) Patent Application Publication
(10) Pub. No.: US 2005/0058757 A1
(43) Pub. Date: Mar. 17, 2005

(54) Snacks having lower acrylamide levels and process for preparation thereof

(76) Inventors: Jae Hoon Kim, Namyanju-city (KR); Soo Hyun Park, Gunpo-city (KR); Woo Suk Kang, Anyang-city (KR); Byung Jung Min, Uiwang-city (KR); Hyeon Jung Kim, Seongnam-city (KR); Baek Gil Seong, Suwon-city (KR); Cheong Tae Kim, Anyang-city (KR); Chul Young Lee, Suwon-city (KR); Sang Suk Oh, Seoul (KR)

Correspondence Address: Yoon Ham;Piper Rudnick LLP, P.O. Box 9271, Reston, VA, 20195, US

(21) Appl. No.: 10/786,595

(22) Filed: Feb. 26, 2004

(30) Foreign Application Priority Data
Mar. 12, 2003 (KR) 10-2003-15475

(51) Int. Cl. A21D 6/00

(52) U.S. Cl. 426/502

(57) ABSTRACT

The present invention provides a process for preparing snacks and snacks prepared thereby, characterized by introducing one or more amino acids selected from the group consisting of glycine, lysine and cystein into raw materials in preparing a wheat-based snack or a potato snack by a conventional process. According to the present invention, snacks may be provided that have much lower acrylamide levels to secure reliability and safety for consumers, while still maintaining such properties as taste, color and texture.

### BACKGROUND OF THE INVENTION

1. Field of the Invention

The present invention relates to snacks having lower acrylamide levels and a process for preparation thereof, and more particularly, to wheat-based snacks and potato snacks having lower acrylamide levels by incorporating certain amino acid(s), and a process for preparation thereof.

2. Description of the Related Art

Recently, controversy has arisen over the health hazard of wheat-based snacks and potato snacks due to the acrylamide, a suspected carcinogen, contained therein. Acrylamide is a colorless chemical that is used in plastics, dye preparation and water purification processes. It rarely occurs naturally and mostly is synthesized or produced artificially. Although it has been reported that acrylamide induces cancer and nerve damage when administered to mice, its effect on man has not been demonstrated. Acrylamide is known to be produced by a reaction of aspartic acid (protein) and glucose (sugar) in potatoes when potatoes are cooked at 120° C.˜180° C. Potatoes exhibit a relatively high aspartic acid content (less than 380 mg per 100 g). Cereals are representative of foods containing both aspartic acid and glucose.

Accordingly, it is highly probable that acrylamide is produced within snacks which are prepared by frying or baking raw materials containing both aspartic acid and glucose.

A wheat-based snack is generally prepared by (1) putting raw materials into a steam mixer to produce dough by gelatinization followed by forming sheets by rolling, (2) aging the rolled sheets followed by shaping, cutting and drying, and (3) puffing the dried dough followed by seasoning and nitrogen flush packaging.

A potato snack formed into chips or sticks is generally prepared by (1) peeling, cutting and washing raw potatoes, (2) blanching the washed potatoes, (3) frying the blanched potatoes immediately after draining, or after freezing storage, and (4) seasoning the fried potatoes followed by nitrogen flush packaging.

If typical food additives are used for reducing the amount of acrylamide produced during the above-described preparation processes, for a wheat-based snack, the taste and texture of the snack deteriorates when any of the frying, baking, parching and puffing is performed for the purpose of bulking, resulting in a totally different product. For a potato snack, problems arise in that frying in oil leads to a change of color or loss of the unique potato taste or flavor as well as reduced texture.

The inventors of the present invention performed extensive research in order to obviate the above-described problems, and have completed the present invention by finding snacks wherein the production of acrylamide is reduced without a significant difference in quality from conventional snacks, can be prepared by adding certain amino acids (glycine, lysine or cysteine) to the raw materials of the snack in a conventional process for preparing a potato or wheat-based snack.

### SUMMARY OF THE INVENTION

Accordingly, an object of the present invention is to prepare snacks having a lower acrylamide content without a significant difference in such qualities as taste, flavor, and appearance from conventional snacks.

According to a first aspect of the present invention for achieving the above object, there is provided a process for preparing a wheat-based snack which comprises the steps of putting raw materials of the wheat-based snack into a steam mixer to produce dough by gelatinization followed by forming sheets by rolling; aging the rolled sheets followed by shaping, cutting and drying; and puffing the dried dough followed by seasoning and nitrogen flush packaging, characterized in that one or more amino acids selected from the group consisting of glycine, lysine and cystein are introduced into the raw materials of the wheat-based snack, as well as and a wheat-based snack prepared thereby.

According to a second aspect of the present invention, there is provided a process for preparing a potato snack which comprises the steps of peeling, cutting and washing the raw potatoes; blanching the washed potatoes; frying the blanched potatoes immediately after draining, or after freezing storage; and seasoning the fried potatoes followed by nitrogen flush packaging, characterized in that the step of blanching the washed potatoes comprises soaking the washed potatoes in warm water to which one or more amino acids selected from the group consisting of glycine, lysine and cystein are added, or that the process further comprises a step of soaking the blanched potatoes in warm water to which one or more amino acids selected from the group consisting of glycine, lysine and cystein are added, as well as a potato snack prepared thereby.

### DETAILED DESCRIPTION OF THE INVENTION

Hereinafter, the present invention will be described in more detail.

First, a process for preparing a wheat-based snack, a first embodiment of the present invention, is described.

First Step

Raw materials are put into a steam mixer to produce dough by gelatinization.

As raw materials, any raw material conventionally used in wheat-based snacks may be used, including wheat flour, starch, frozen potatoes, frozen onions, white sugar, and purified salt, for example.

The acrylamide content in the final snack may be lowered by introducing one or more amino acids selected from the group consisting of glycine, lysine and cystein into the raw materials.

The amount of addition ranges from 0.05 to 1.5 parts by weight for 100 parts by weight of the above raw materials. When the added amount is less than 0.05 parts by weight, the acrylamide lowering effect is hardly significant, while an added amount greater than 1.5 parts by weight results in the deterioration of taste, texture, color and the like of the snack.

Although operation conditions for the steam mixer are not limited particularly, it is preferred that the screw rotation speed be within 190-210 rpm and the inside temperature be within 105-115° C., as is usual.

The resulting dough is then sheeted by rolling according to any conventional process. It is preferable that rolling produces sheets having a thickness of about 2.8 nun.

Second Step

Rolled sheets are aged under conventional conditions. Aging is preferably performed at 13° C. for 12 hours.

The aged sheets are then shaped by a conventional process, forming and cutting into about 30 mm length being preferred.

The resulting dough slices are dried in a conventional manner. The formed and cut dough (semi-finished product) is preferably introduced into a dryer where it is dried at 70° C. for 5 hours to a moisture content of 18%, allowed to stand, and then introduced into a second dryer, where it is dried at 80° C. at a retention time of 16 hour to a moisture content of 10%, and then discharged.

Third Step

The dried dough is puffed. There is no particular limitation on the method of puffing. Such a method includes flying, baking, parching, and air puffing. Thereafter, according to any conventional process, seasoning is applied so as to impart taste to the puffed snack, and the snack product is cooled to ambient temperature to suppress the generation of condensation water and mold, and then packaged in an automatic nitrogen flush packing machine. Nitrogen flush is used to remove oxygen in the package, thereby suppressing fat rancidity.

Second, a process for preparing a potato snack is described.

First Step

Potatoes, which are the main raw material, are put into a peeling machine. The peeled potatoes are then introduced into a slicer. For a potato snack in chip form, potatoes are sliced into a constant thickness using the centrifugal force of a rotating cutter. In the case of a stick form snack, potatoes are also cut into a predetermined size. Typically, a thickness of 1.35 mm is preferred for the chip form, and about 0.5 cm×0.5 cm (width×length) size for the stick form.

Sliced potatoes are then washed for removal of starch on their surfaces.

Second Step

Variant 1: Sliced and washed potatoes are blanched in warm water to which one or more amino acids selected from the group consisting of glycine, lysine and cystein have been added.

Variant 2: Sliced and washed potatoes are blanched conventionally and, in a subsequent step, soaked in warm water to which one or more amino acids selected from the group consisting of glycine, lysine and cystein have been added.

In Variants 1 and 2 described above, the amount of one or more amino acids selected from the group consisting of glycine, lysine and cystein to be added ranges from 0.05 to 1.5 parts by weight per 100 parts by weight of warm water. When the added amount is less than 0.05 parts by weight, the acrylamide lowering effect is hardly significant, while an added amount greater than 1.5 parts by weight results the deterioration of taste, texture, color and the like of the resulting snack.

In Variant 1, the blanching operation may be performed under conventional conditions. It is preferred that the blanching is performed at 70° C. for 5 minutes such that the specific amino acid used may properly permeate into chips or sticks without softening the texture of the potatoes.

In Variant 2, the blanching operation may be performed under conventional conditions, which is also the case with the subsequent soaking in warm water containing amino acids. It is preferred that the blanching is performed at 90° C. for 1 min 30 sec, and then the soaking on warm water containing amino acids at 70° C. for 5 minutes such that the specific amino acid used may properly permeate into chips or sticks without softening the texture of the potatoes.

During the blanching operation, potatoes lose some of their unique taste due to the dissolution of starch. However, when the above amino acids are used, the unique palatable taste of the amino acids and the unique potato taste bring about synergy, resulting in a minimal variation in taste.

Third Step

Potatoes obtained in the Second Step are drained and stored as such or frozen, according to any conventional storage protocols. For storage in the frozen state, 24 hours at −5° C. is desirable.

Next, the potato slices are puffed by frying in oil. There is no particular limitation on the method of puffing, which includes frying in oil under ambient pressure and frying under reduced pressure. Frying under ambient pressure may preferably be conducted at 182° C. for 1 min 30 sec in oil, and frying under reduced pressure may preferably conducted at 120° C. for 20 minutes in oil. Evidently, using reduced pressure frying (120° C.) is more effective for suppressing the generation of acrylamide than using ambient pressure frying (182° C.) to prepare a potato snack (chip or stick form)

Fourth Step

According to any conventional process, seasoning is applied so as to impart taste to the puffed snack (chip or stick form), and the snack product is cooled to ambient temperature to suppress the generation of condensation water and mold, and then packaged in an automatic nitrogen flush packing machine. Nitrogen flush is used to remove oxygen in the package, thereby suppressing fat rancidity.

Preferred examples, comparative examples, test examples of the present invention will now be described. However, it should be appreciated that these examples are given only for illustrating the present invention in more detail and should not be construed as limiting the scope of protection of the present invention.

### PREPARATION EXAMPLES FOR WHEAT-BASED SNACKS

### EXAMPLE 1

Wheat flour 60 kg, starch 22 kg, frozen potatoes 11 kg, frozen onions 3.5 kg, amino acid (glycine) 0.05 kg, white sugar 2.5 kg and purified salt 1.0 kg were introduced into a steam mixer, and the mixer was operated at a screw rotation speed of 200 rpm, an inside temperature of 110° C., a steam pressure of 4 kg/cm² to give gelatinized dough, which was then sheeted to a thickness of 2.8 mm by rolling. This sheet was aged at 13° C. for 12 hours, and passed through a forming cutter to give dough cut into about 30 mm length. The resulting dough was introduced into a dryer, dried at 70° C. for 5 hours to yield wheat-based snack semi-finished products having a moisture content of 18%.

### EXAMPLE 2

Wheat-based snack semi-finished products were prepared in the same manner as in Example 1 except that the amount of glycine added was 0.1 kg.

### EXAMPLE 3

Wheat-based snack semi-finished products were prepared in the same manner as in Example 1 except that the amount of glycine added was 1.5 kg.

### EXAMPLE 4

Wheat-based snack semi-finished products were prepared in the same manner as in Example 3 except that lysine 1.5 kg was used instead of glycine.

### EXAMPLE 5

Wheat-based snack semi-finished products were prepared in the same manner as in Example 3 except that cystein 1.5 kg was used instead of glycine.

### EXAMPLE 6

Wheat-based snack semi-finished products were prepared in the same manner as in Example 1 except that glycine 0.75 kg and lysine 0.75 kg were used instead of glycine.

### EXAMPLE 7

Wheat-based snack semi-finished products were prepared in the same manner as in Example 1 except that glycine 0.75 kg and cystein 0.75 kg were used instead of glycine.

### EXAMPLE 8

Wheat-based snack semi-finished products were prepared in the same manner as in Example 1 except that glycine 0.5 kg, lysine 0.5 kg and cystein 0.5 kg were used instead of glycine.

### COMPARATIVE EXAMPLE 1

Wheat-based snack semi-finished products were prepared in the same manner as in Example 1 except that the amino acid (glycine) was not used.

### COMPARATIVE EXAMPLE 2

Wheat-based snack semi-finished products were prepared in the same manner as in Example 1 except that the amino acid (glycine) was used in an amount of 0.03 kg.

### COMPARATIVE EXAMPLE 3

Wheat-based snack semi-finished products were prepared in the same manner as in Example 1 except that the amino acid (glycine) was used in an amount of 3.0 kg.

### TEST EXAMPLE 1

Wheat-based snacks prepared according to Examples 1 to 8 and Comparative Examples 1 to 3, were assessed for their acrylamide contents by using the acrylamide analysis of FDA (U.S. FDA; Detection and Quantitation of Acrylamide in Foods. Jul. 23, 2002), which is specifically described:

One pouch (90 g) of each of the wheat-based snacks prepared according to Examples 1 to 8 and Comparative Examples 1 to 3 was finely pulverized and 10 g portions were taken. Each 10 g portion was placed in a 250 ml beaker, and after 99 ml of water and 1 ml of internal standard material (¹³C-labeled acrylamide in 0.1% formic acid) were added, extracted for 10 minutes. The sample was centrifuged at 9,000 rpm for 30 minutes, and purified by centrifugation at 9,000 rpm using a Maxi-Sin filter tube and 0.45 um PVDF, until at least 5 ml of the solution is recovered. The resulting fraction was purified using an OASIS SPE cartridge, and then by Varian SPE cartridge. Quantitative analysis was performed by the internal standard quantitation method using a Quattro Micro triple quadrapole mass spectrometer (Micromass Inc., Manchester, U.K.) and HPLC (Sykam, Germany)(column: Aqua C18 HPLC column (2×250 mm), Phenomonex, Torrance, Calif., USA).

The results are reported in Table 1.

### TEST EXAMPLE 2

A sensory evaluation was run in which 30 sensory evaluation panel members analyzed taste, color of the puffed material and texture of wheat-based snacks prepared according to Examples 1 to 8 and Comparative Examples 1 to 3.

The results are reported in Table 1.

TABLE 1

| | | | Color of | |
|---|---|---|---|---|
| | Acrylamide | | puffed | Texture of puffed |
| | content (ppb) | Taste | material | material |
| Example 1 | 813 | Strong | Uniform | Soft and good |
| | | | | mouth feel |
| Example 2 | 658 | Strong | Uniform | Soft and good |
| | | | | mouth feel |
| Example 3 | 364 | Strong | Uniform | Soft and good |
| | | | | mouth feel |
| Example 4 | 550 | Strong | Uniform | Soft and good |
| | | | | mouth feel |
| Example 5 | 293 | Strong | Uniform | Soft and good |
| | | | | mouth feel |
| Example 6 | 403 | Strong | Uniform | Soft and good |
| | | | | mouth feel |
| Example 7 | 362 | Strong | Uniform | Soft and good |
| | | | | mouth feel |
| Example 8 | 385 | Strong | Uniform | Soft and good |
| | | | | mouth feel |
| Comparative | 1219 | Moderate | Uniform | Soft and good |
| Example 1 | | | | mouth feel |
| Comparative | 930 | Moderate | Uniform | Soft and good |
| Example 2 | | | | mouth feel |
| Comparative | 190 | Very strong | Dark | Rough and tough |
| Example 3 | | | | |

Table 1 indicates that wheat-based snacks containing amino acids according to the present invention have significantly reduced acrylamide contents in comparison with conventional wheat-based snacks (Comparative Example 1), still showing no significant difference in such properties as taste, color and texture. On the other hand, when the amino acid is used in overly small amounts (Comparative Example 2), the acrylamide lowering effect was not significant, whereas overly large amounts (Comparative Example 3) caused such problems as very strong taste, dark color and rough texture.

### PREPARATION EXAMPLES FOR POTATO SNACKS

### EXAMPLE 9

Potatoes were placed in a peeling machine and peeled at a speed of about 200 rpm for about 40 sec. The peeled potatoes were introduced into a slicer to be sliced to a thickness of 1.35 mm, and then washed for about 1 min 30 sec. Amino acid (lysine) 0.05 kg was dissolved in warm water 100 kg, to which solution the washed potatoes 100 kg were introduced and blanched using a conventional method at a temperature of 70° C., a retention time of 5 min. The blanched potatoes were drained and fried in oil under ambient pressure (182° C.) for 1 min 30 sec, to give potato chips.

### EXAMPLE 10

Potato chips were prepared in the same manner as in Example 9 except that the amount of lysine used was 0.1 kg.

### EXAMPLE 11

Potato chips were prepared in the same manner as in Example 9 except that the amount of lysine used was 1.5 kg.

### EXAMPLE 12

Potato chips were prepared in the same manner as in Example 11 except that the 1.5 kg of glycine was used instead of lysine.

### EXAMPLE 13

Potato chips were prepared in the same manner as in Example 11 except that 1.5 kg of cystein was used instead of lysine.

### EXAMPLE 14

Potato chips were prepared in the same manner as in Example 9 except that lysine 0.75 kg and glycine 0.75 kg were used instead of lysine.

### Example 15

Potato chips were prepared in the same manner as in Example 9 except that lysine 0.75 kg and cystein 0.75 kg were used instead of lysine.

### EXAMPLE 16

Potato chips were prepared in the same manner as in Example 9 except that lysine 0.5 kg, glycine 0.5 kg and cystein 0.5 kg were used instead of lysine.

### COMPARATIVE EXAMPLE 4

Potato chips were prepared in the same manner as in Example 9 except that the amino acid (lysine) was not used.

### COMPARATIVE EXAMPLE 5

Potato chips were prepared in the same manner as in Example 9 except that the amino acid (lysine) was used in an amount of 0.03 kg.

### COMPARATIVE EXAMPLE 6

Potato chips were prepared in the same manner as in Example 9 except that the amino acid (lysine) was used in an amount of 3.0 kg.

### EXAMPLE 17

Potato chips were prepared in the same manner as in Example 9 except that instead of frying under ambient pressure, at a temperature of 182° C. for 1 min 30 sec, frying was conducted under reduced pressure, at a temperature of 120° C. for 20 minutes

### EXAMPLE 18

Potato chips were prepared in the same manner as in Example 17 except that the amount of lysine used was 0.1 kg.

### EXAMPLE 19

Potato chips were prepared in the same manner as in Example 17 except that the amount of lysine used was 1.5 kg.

### EXAMPLE 20

Potato chips were prepared in the same manner as in Example 19 except that the 1.5 kg of glycine was used instead of lysine.

### EXAMPLE 21

Potato chips were prepared in the same manner as in Example 19 except that 1.5 kg of cystein was used instead of lysine.

### EXAMPLE 22

Potato chips were prepared in the same manner as in Example 17 except that lysine 0.75 kg and glycine 0.75 kg were used instead of lysine.

### EXAMPLE 23

Potato chips were prepared in the same manner as in Example 17 except that lysine 0.75 kg and cystein 0.75 kg were used instead of lysine.

### EXAMPLE 24

Potato chips were prepared in the same manner as in Example 17 except that lysine 0.5 kg, glycine 0.5 kg and cystein 0.5 kg were used instead of lysine.

### COMPARATIVE EXAMPLE 7

Potato chips were prepared in the same manner as in Example 17 except that the amino acid (lysine) was not used.

### COMPARATIVE EXAMPLE 8

Potato chips were prepared in the same manner as in Example 17 except that the amino acid (lysine) was used in an amount of 0.03 kg.

### COMPARATIVE EXAMPLE 9

Potato chips were prepared in the same manner as in Example 17 except that the amino acid (lysine) was used in an amount of 3.0 kg.

### TEST EXAMPLE 3

Potato snacks prepared according to Examples 9 to 24 and Comparative Examples 4 to 9, were assessed for their acrylamide contents in the same manner as in Test Example 1.

The results are reported in Tables 2A and 2B.

### TEST EXAMPLE 4

A sensory evaluation was run in the same manner as in Test Example 2 for potato snacks prepared according to Examples 9 to 24 and Comparative Examples 4 to 9. The results are reported in Tables 2A and 2B.

TABLE 2A

| | | | Color of | |
|---|---|---|---|---|
| | Acrylamide | | puffed | Texture of puffed |
| | content (ppb) | Taste | material | material |
| Example 9 | 970 | Strong | Uniform | Soft and good |
| | | | | mouth feel |
| Example 10 | 679 | Strong | Uniform | Soft and good |
| | | | | mouth feel |
| Example 11 | 250 | Strong | Uniform | Soft and good |
| | | | | mouth feel |
| Example 12 | 309 | Strong | Uniform | Soft and good |
| | | | | mouth feel |
| Example 13 | 177 | Strong | Uniform | Soft and good |
| | | | | mouth feel |
| Example 14 | 390 | Strong | Uniform | Soft and good |
| | | | | mouth feel |
| Example 15 | 250 | Strong | Uniform | Soft and good |
| | | | | mouth feel |
| Example 16 | 341 | Strong | Uniform | Soft and good |
| | | | | mouth feel |
| Comparative | 1250 | Moderate | Uniform | Soft and good |
| Example 4 | | | | mouth feel |
| Comparative | 1050 | Moderate | Uniform | Soft and good |
| Example 5 | | | | mouth feel |
| Comparative | 170 | Very strong | Dark | Moderately rough |
| Example 6 | | | | |

TABLE 2B

| | | | Color of | |
|---|---|---|---|---|
| | Acrylamide | | puffed | Texture of puffed |
| | content (ppb) | Taste | material | material |
| Example 17 | 631 | Strong | Uniform | Soft and good |
| | | | | mouth feel |
| Example 18 | 476 | Strong | Uniform | Soft and good |
| | | | | mouth feel |
| Example 19 | 150 | Strong | Uniform | Soft and good |
| | | | | mouth feel |
| Example 20 | 140 | Strong | Uniform | Soft and good |
| | | | | mouth feel |
| Example 21 | 110 | Strong | Uniform | Soft and good |
| | | | | mouth feel |
| Example 22 | 240 | Strong | Uniform | Soft and good |
| | | | | mouth feel |
| Example 23 | 198 | Strong | Uniform | Soft and good |
| | | | | mouth feel |
| Example 24 | 213 | Strong | Uniform | Soft and good |
| | | | | mouth feel |
| Comparative | 1250 | Moderate | Uniform | Soft and good |
| Example 7 | | | | mouth feel |
| Comparative | 950 | Moderate | Uniform | Soft and good |
| Example 8 | | | | mouth feel |
| Comparative | 118 | Very strong | Dark | Moderately rough |
| Example 9 | | | | |

Table 2 indicates that potato snacks containing amino acids according to the present invention have significantly reduced acrylamide contents in comparison with conventional potato snacks (Comparative Examples 4 and 7), still showing no significant difference in such properties as taste, color and texture. On the other hand, when the amino acid is used in overly small amounts, the acrylamide lowering effect was not significant, whereas overly large amounts caused such problems as very strong taste, dark color and rough texture.

As described in detail, by using certain amino acids, wheat-based snacks and potato snacks may be provided that have much lower acrylamide to secure reliability and safety for consumers, still with high quality in such properties as taste, color and texture.

1. A process for preparing a wheat-based snack comprising the steps of putting raw materials of the wheat-based snack into a steam mixer to produce dough by gelatinization followed by forming sheets by rolling; aging the rolled sheets followed by shaping, cutting and drying; and puffing the dried dough followed by seasoning and nitrogen flush packaging, characterized in that one or more amino acids selected from the group consisting of glycine, lysine and cystein are introduced into the raw materials of the wheat-based snack.

2. The process of claim 1 wherein the one or more amino acids selected from the group consisting of glycine, lysine and cystein are introduced with a ratio of from 0.05 to 1.5 parts by weight to 100 parts by weight of the said raw materials.

3. A wheat-based snack prepared according to claim 1.

4. A process for preparing a potato snack comprising the steps of peeling, cutting and washing raw potatoes; blanching the washed potatoes; frying the blanched potatoes immediately after draining, or after freezing storage; and seasoning the fried potatoes followed by nitrogen flush packaging, characterized in that the step of blanching the washed potatoes comprises soaking the washed potatoes in warm water to which one or more amino acids selected from the group consisting of glycine, lysine and cystein are added.

5. A process for preparing a potato snack comprising the steps of peeling, cutting and washing the raw potatoes; blanching the washed potatoes; frying the blanched potatoes immediately after draining, or after freezing storage; and seasoning the fried potatoes followed by nitrogen flush packaging, characterized in that the process further comprises a step of soaking the blanched potatoes in warm water to which one or more amino acids selected from the group consisting of glycine, lysine and cystein are added.

6. The process of claim 4 wherein the one or more amino acids selected from the group consisting of glycine, lysine and cystein are introduced with a ratio of from 0.05 to 1.5 parts by weight to 100 parts by weight of warm water.

7. A potato snack prepared according to claim 4.

8. A wheat-based snack prepared according to claim 2.

9. The process of claim 5 wherein the one or more amino acids selected from the group consisting of glycine, lysine and cystein are introduced with a ratio of from 0.05 to 1.5 parts by weight to 100 parts by weight of warm water.

10. A potato snack prepared according to claim 5.

11. A potato snack prepared according to claim 6.
